(19) United States
(12) Patent Application Publication
(10) Pub. No.: US 2004/0120756 A1
(43) Pub. Date: Jun. 24, 2004

(54) Shaft telescopic device

(76) Inventor: Tong-Hsin Cheng, Taipei (TW)

Correspondence Address: Tong-Hsin Cheng, P.O. Box No. 6-57, Chung-Ho, Taipei, 235, TW

(21) Appl. No.: 10/323,784

(22) Filed: Dec. 20, 2002

(51) Int. Cl. F16B 7/10

(52) U.S. Cl. 403/109.1

(57) ABSTRACT

A shaft telescopic device includes a shaft base, a fixed shaft with a leader pin on the upper end thereof, a joint plate assembly, and a pull link covers around the leader pin upon the shaft base. The joint plate assembly is disposed inside the fixed shaft, which is crisscrossed by a plurality of plates having upper, center, and lower positioning sections. By controlling the compression and extension status of the joint plate assembly, the upward and downward movements of the pull link thereby allowing the provision component inside the fixed shaft to achieve the purposes of closing or of usage.

### BACKGROUND OF THE INVENTION

1) FIELD OF THE INVENTION

This present invention relates to a shaft telescopic device, more particularly to a shaft with telescopic function, which can be broadly applied to provision components such as lipsticks, lip protectors, and powder sticks, or to pens such as ball pens or art pens.

2) THE DESCRIPTION OF PRIOR ART

A variety of pens, including pencils, ball pens, and fountain pens, are important tools for opinions expression in our everyday life. From children, youths to the elders, everyone owns certain pens as necessary tools for needs at all time.

Due to the different features and usage purposes of each kind, the structure of which is also differentiated. For instance, a pencil includes the wood pencils, and automatic pencils, while ball pens can be either in oil or water ink, including fixed, pressed, or rotary extensible control structure. The fountain pens have extensible control also such as fixed or rotary structure.

Take automatic pencil for example, it is consisted of a pencil lead, a cover, a pen clip, a compressing spring, a round spring and a switch. The pencil lead and cover respectively set in consequence in the lower and upper sections to make the 2-stage compressing structure workable inside the cover and to produce the 2-stage switch of the pencil lead.

On top of the cover, there are an additional compressing spring and a round spring with different external diameter. The compressing spring with bigger external diameter was utilized and displayed on the upholding bearing of the cover. A position ring of pen clip configures on the top of the compressing spring, while the neck of the pen clip is interlocking on the upper inlay for side edge of upholding bearing in the cover. Thus when the pen clip is open to clip a cloth or other items, by means of the fulcrum supported by the neck, the lever function is therefore caused for pen clip. Furthermore, as for the round spring with smaller internal diameter, it is put inside the compressing spring and the position ring of pen clip to cooperate with the compressing shaft above the cover. The top end of the compressing shaft is screwed on a switch for the round spring to provide flexibility of the compressing controller in accordance with the switch motion.

Known from the above description of the conventional telescopic control structure of the pen in the market, it can of course effectively facilitate the ease of use by means of the flexible compressing control. However, due to the missing of a real innovative structure, it is unsuccessful in appealing to the consumers to stimulate the purchasing desires, ever since the telescopic structure of this kind of pen has been in the market for years.

Thus, based on the rich experiences on research, design and manufacturing of the related products, the innovator of this invention finally succeeded in developing this innovative shaft telescopic device after continuous researches and experiments, to provide the consumers a brand-new, interesting and motion precise shaft telescopic device, to stimulate the buyers market and raise the purchasing desires effectively.

### SUMMARY OF THE INVENTION

The present invention, shaft telescopic device, is comprised of a shaft base, a fixed shaft, a joint-plate assembly, and a pull link. On the upper end of the shaft base, there is a leader pin, each of two sides thereof forming a first slotting and corresponding to first pivot hole thereon respectively. The fixed shaft is disposed inside the shaft base, wherein a second slotting is formed thereof corresponding to first slotting respectively, and at the optimal height each has second pivot hole, whereas a provision component can be fixed inside the fixed shaft. The joint plate assembly is pivotally fixed inside the fixed shaft, which is crisscrossed by a plurality of plates having upper, center, and lower positioning sections. The pull link covers around the leader pin on the shaft base, with third pivot holes is set at optimal height on each side thereof. The upper positioning section of this joint plate assembly is pivotally fixed with the third pivot holes, whereas the center positioning section fixed with first pivot holes and the lower positioning section fixed with the second pivot holes.

The primary objective of the present invention is to control the compression and extension status of the joint plate assembly by means of upward and downward movement of the pull link, allowing the provision component inside fixed shaft achieve the purposes of closing or of usage.

Another objective of the present invention is to widely apply the shaft telescopic device on the provision of cosmetics such as lipsticks, lip protectors, and powder sticks, or on the provision of a variety of pens such as ball pens or art pens.

To enable the further understanding of the said objectives as well as the structure details of the invention herein, the detailed description of the invention hereby along with the brief description of the drawings below shall provide additional elaboration.

### BRIEF DESCRIPTION OF THE DRAWINGS

FIG. 1 is an exploded perspective view of the preferred embodiment of the present invention applying on lipsticks.

FIG. 2 is a cross-sectional view of the preferred embodiment of the present invention applying on pen.

FIG. 3 is a cross-sectional view showing the status in lifting movement of FIG. 2.

### DETAILED DESCRIPTION OF THE PREFERRED EMBODIMENTS

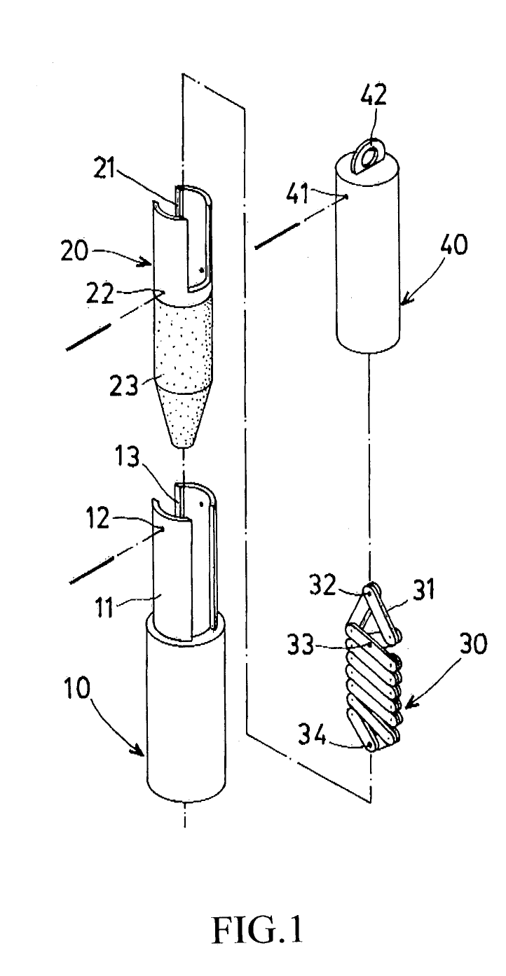

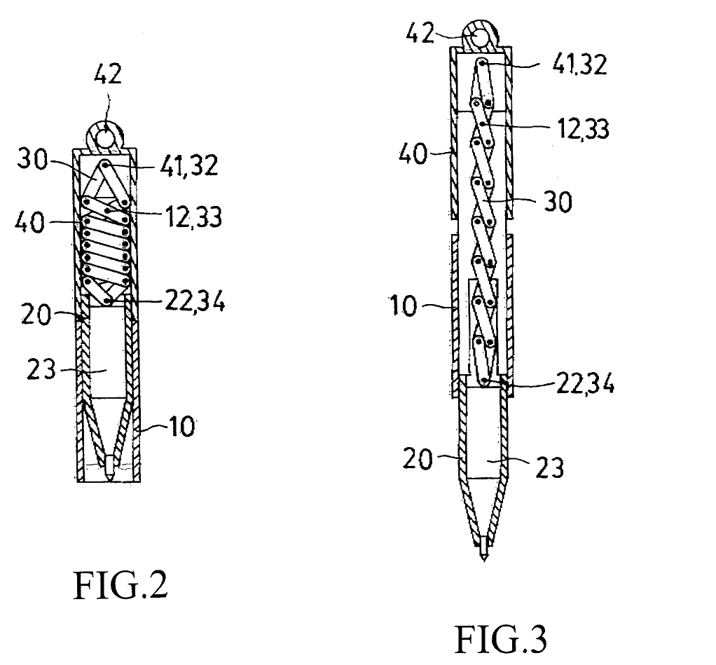

Referring to FIG. 1 and FIG. 2, a shaft telescopic device of the invention is comprised of a shaft base 10, a fixed shaft 20, a joint plate assembly 30 and a pull link 40, wherein, a shaft base 10 is in the shape of a hollow cylinder and a leader pin 11 is disposed on the upper end thereof, each of two opposite sides of the leader pin 11 has first pivot holes 12 and corresponds to each neighboring sides forming a first slotting 13.

The fixed shaft 20 is also in the shape of a hollow cylinder which is disposed in shaft base 10, the upper end thereof corresponds to the first slotting 13 respectively forming second slotting 21, and at the optimal height of the neighboring sides thereof each has second pivot holes 22, wherein a provision component 23 is provided inside the fixed shaft 20.

The joint assembly 30 forming by a plurality of rectangular plates 31 which are pivotally connected by upper positioning section 32, center positioning section 33 and lower positioning section 34 and are disposed inside the fixed shaft 20.

The pull link 40 covers around the leader pin 11 on a shaft base 10, with third pivot holes 41 are set at optimal height on each side thereof. On the top of the pull link 40, a annul et 42 is formed thereof for necklace or key ring to thread through.

The upper positioning section 32 of the joint assembly 30 is pivotally fixed between two of the third pivot holes 41 of the pull link 40, whereas the center positioning section 33 is pivotally fixed between two of the first pivot holes 12 of the leader pin 11, and the lower positioning section 34 is pivotally fixed between two of the second pivot holes 22 of the fixed shaft 20. The provision components 23 of fixed shaft 20 can be applied for cosmetics such as lipsticks, lip protectors or powder sticks, or pens such as ball pens or art pens.

Referring to FIG. 2 and FIG. 3, as shown, when the shaft telescopic device of present invention reaches closing status thereof, the fixed shaft 20 is fully placed inside the shaft base 10, and the bottom edge of the pull link 40 compresses upon the upper end of shaft base 10. In the mean while, the joint plate assembly 30 performs the compressing status, and two sides thereof are restricted respectively on the first slotting 13 of the shaft base 10 and on the second slotting 21 of the fixed shaft 20.

When this telescopic device is in usage, the major function is to lift up the pull link 40 forming a space at the bottom edge from the upper end of the shaft base 10 thereof, whereas the pull link 40 is lifted, which simultaneously connects the upper positioning section 32 of the joint plate assembly 30 to facilitate each crisscrossed plates 31 of the joint plate assembly 30 in an overall extension status. When the joint plate assembly 30 is in the extension status, the lower positioning section 34 is fixed with the second pivot holes 22 thereby pressing downwardly to enable the provision component 23 originally inside the fixed shaft 20 being projected outside shaft base 10, for usage purpose. On the contrary, when the pull link 40 pulls downwardly to make the bottom edge right on the top of the shaft base 10, the joint plate assembly 30 is compressed to retract the fixed shaft 20 into the shaft base 10, for closing purpose.

In addition to achieve the purposes of closing or of usage for the provision component 23 inside the fixed shaft 20, by means of perfectly control of the pull link 40 in compression or extension status relative to the joint plate assembly 30, a restriction device can be installed to the present invention in an appropriate position (not demonstrated in the Figures), to prevent the provision component 23 from retracting randomly into the fixed shaft 20 while in usage status. For sure, this restriction device can be a conjoinment design of recesses and flanges or a flexible compressive device to confine the location of the fixed shaft 20 after being downwardly moved thereof.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A shaft telescopic device comprising:
a shaft base having a leader pin formed on the upper end thereof, the leader pin on two side thereof each has first pivot holes, corresponds to each neighboring sides thereof forming first slotting;
a fixed shaft is disposed inside the shaft base, corresponding to the first slotting respectively the fixed shaft has second slotting; the fixed shaft has second pivot holes at the optimal height on two sides thereof, whereas a provision component is fixed inside the fixed shaft;
a joint plate assembly is disposed inside the fixed shaft, having a plurality of crisscrossed plates consist of upper, center, and lower positioning sections;
a pull link covers around a leader pin on the shaft base, having third pivot holes at optimal height on each corresponding side thereof;
an upper positioning section of the joint plate assembly is pivotally fixed between third pivot holes, whereas the center positioning section is pivotally fixed between the first pivot holes of the leader pin and the lower positioning section is pivotally fixed between the second pivot holes; the upward and downward movement of the pull link thereby allowing the provision component inside the fixed shaft to achieve the goal of closing or of usage, by controlling the joint plate assembly in compressive or extensible status.

2. The shaft telescopic device in accordance with claim 1, wherein the provision component inside the fixed shaft is applied for cosmetics.

3. The shaft telescopic device in accordance with claim 1, wherein the provision component inside said fixed shaft is applied for a variety of pens.

4. The shaft telescopic device in accordance with claim 1, wherein on the top of the pull link forming an annulet is applied for necklace or key ring to thread through.

5. The shaft telescopic device in accordance with claim 1, wherein a restrictive device forming at optimal position of the shaft telescopic device to confine the downward movement of the fixed shaft.

6. The shaft telescopic device in accordance with claim 5, wherein the restriction device is designed by conjoinment of flanges and recesses.

7. The shaft telescopic device in accordance with claim 5, wherein the restriction device is a flexible compressing device.
